(19) United States
(12) Patent Application Publication
(10) Pub. No.: US 2019/0056732 A1
(43) Pub. Date: Feb. 21, 2019

(54) AUTOMATED DRIVING ASSISTANCE APPARATUS, AUTOMATED DRIVING ASSISTANCE SYSTEM, AUTOMATED DRIVING ASSISTANCE METHOD AND AUTOMATED DRIVING ASSISTANCE PROGRAM

(71) Applicant: OMRON Corporation, Kyoto-shi, Kyoto (JP)

(72) Inventors: Hatsumi AOI, Kyotanabe-shi (JP); Masato KAWADE, Kyoto-shi (JP); Hideto HAMABASHIRI, Moriyama-shi (JP)

(73) Assignee: OMRON Corporation, Kyoto-shi, KYOTO (JP)

(21) Appl. No.: 15/768,847

(22) PCT Filed: Oct. 19, 2016
(86) PCT No.: PCT/JP2016/080983

§ 371 Date: Apr. 17, 2018

(30) Foreign Application Priority Data
Nov. 20, 2015 (JP) 2015-227326

(51) Int. Cl. G05D 1/00; B60W 40/08; B60W 50/14; G06K 9/00

(52) U.S. Cl. CPC G05D 1/0061; B60W 40/08; B60W 50/14; B60W 2540/22; B60W 2720/10; B60W 2040/0872; G06K 9/00845

(57) ABSTRACT

An automated driving assistance apparatus assists automated driving control of a passenger car, and includes a driver monitoring unit and a manual driving recovery level setting unit. The driver monitoring unit monitors the state of the driver that is driving the passenger car. The manual driving recovery level setting unit sets, in a stepwise manner, a level indicating whether or not a switch can be made from automated driving to manual driving in a predetermined switching zone, based on the state of the driver detected by the driver monitoring unit.

### TECHNICAL FIELD

The present invention relates to an automated driving assistance apparatus, an automated driving assistance system, an automated driving assistance method and an automated driving assistance program for assisting automated driving of an automobile.

### RELATED ART

In recent years, for example, automated driving techniques for performing automated driving of a vehicle on a roadway such as a highway have been used.

Regarding automated driving techniques, the National Highway Traffic Safety Administration (NHTSA) of the U.S. Department of Transportation has set four automated driving levels including Level 4 at which fully-automated traveling is possible.

Among these driving levels, Level 3 that is set as a semi-automated traveling system is defined as a state where accelerating, steering, and braking are all performed by the system, and when the system makes a request, the driver responds to the request. Therefore, in the system of Level 3, it is important to check whether or not the driver is in a state of being able to recover manual driving during automated driving.

For example, Patent Document 1 discloses an automated driving apparatus for a vehicle that smoothly makes a switch from automated driving to manual driving by setting a relay point before an area in which vehicles can stop in an automated driving zone.

### RELATED ART DOCUMENTS

### Patent Documents

### Patent Document 1: JP 2008-290680A

### SUMMARY OF THE INVENTION

### Problem to be Solved by the Invention

However, in the above conventional automated driving assistance apparatus has a problem as described below.

In the automated driving assistance apparatus disclosed in the above document, when it is detected that the driver is sleeping, it is determined that a switch to manual driving cannot be made, and the vehicle is stopped in a parking area, a service area, or the like without exception. However, for example, appropriately making a switch to manual driving according to the state of the driver, such as the time required before it is possible to recover manual driving when the driver is operating a smartphone, eating, reading, or the like is not taken into consideration.

The invention aims to provide an automated driving assistance apparatus, an automated driving assistance system, an automated driving assistance method and an automated driving assistance program that can provide appropriate support when switching from automated driving to manual driving, according to the state of the driver, such as the time required before it is possible to recover manual driving.

### Means for Solving the Problems

An automated driving assistance apparatus according to a first invention is an automated driving assistance apparatus for assisting automated driving control of a vehicle, and includes a driver monitoring unit and a manual driving recovery level setting unit. The driver monitoring unit monitors a state of a driver that is driving the vehicle. The manual driving recovery level setting unit sets, in a stepwise manner, a level indicating whether or not a switch can be made from automated driving to manual driving in a predetermined switching zone, based on the state of the driver detected by the driver monitoring unit.

Here, in the automated driving assistance apparatus that performs automated driving of a vehicle, the state of the driver of the vehicle during automated driving control is monitored, and a level indicating whether or not a switch can be made from automated driving to manual driving is set in a stepwise manner, according to the state of the driver.

Here, as the state of a driver that is monitored, a forward focused state or a distracted state in which manual driving can be quickly coped with, a smartphone operating state, an eating/drinking state, a smoking state, or a reading state in which manual driving can be coped with after a predetermined time has elapsed, or a sleeping state or the like in which there is a risk that manual driving cannot be coped with even after a predetermined time has elapsed is conceivable, for example. Additionally, such a state of a driver is allocated to a level that has been set in stepwise order, using an image shot by a camera installed in front of the driver and biological information (e.g., brain waves, or heart rate) of the driver detected using a sensor of each of various types, for example.

In addition, the predetermined switching zone in which a switch is made from automated driving to manual driving refers to a zone that is automatically set at a position that is several kilometers before the exit of the IC closest to the destination when a vehicle is traveling on a highway, for example. Alternatively, in the case where information regarding traffic congestion, an accident or the like is obtained during traveling, the predetermined switching zone may be a zone that is automatically set at a position that is several kilometers before the traffic congestion zone.

Accordingly, by setting a plurality of levels in a stepwise manner according to the state of a driver during automated driving, it is possible to easily determine whether or not there will be a problem if a switch is made from automated driving to manual driving in the predetermined switching zone in the current state.

Thus, for example, in the case where a level indicating the state where the driver cannot quickly cope with manual driving is set, it is possible to issue an alert (sound, display, etc.) for prompting the driver to be able to cope with manual driving. Alternatively, in the case where a level indicating the state where the driver cannot cope with manual driving even after a predetermined time has elapsed is set, it is possible to automatically stop the vehicle in a safe shelter area (e.g., a parking area or a side strip) while continuing automated driving.

As a result, appropriate support can be provided according to the state of the driver, when switching from automated driving to manual driving.

An automated driving assistance apparatus according to a second invention is the automated driving assistance apparatus according to the first invention, and further includes a manual driving recovery time calculation unit that estimates a time before the driver can cope with manual driving, according to the level that has been set in a stepwise manner by the manual driving recovery level setting unit.

Here, an estimated time required before the driver can cope with manual driving is calculated according to the level that has been set according to the above-described state of the driver.

Here, for example, the estimated time is calculated as 2 to 3 seconds in the case of a forward focused state and a distracted state in which manual driving can be quickly coped with, and 5 to 10 seconds in the cases of a smartphone operating state, an eating/drinking state, a smoking state, and a reading state in which manual driving can be coped with after a predetermined time has elapsed. Additionally, regarding a sleeping state and the like in which there is a risk that manual driving cannot be coped with even after a predetermined time has lapsed, for example, an estimated time of 3 minutes or more is set, or it suffices to set that recovering manual driving is impossible.

Accordingly, it is possible to recognize the time required before manual driving can be recovered, and thus it is possible to easily determine whether or not a state in which the driver can cope with manual driving will be achieved before the predetermined switching zone is reached from the current position.

An automated driving assistance apparatus according to a third invention is the automated driving assistance apparatus according to the second invention, and further includes an alert generation unit that issues an alert to the driver in a case where a time calculated by the manual driving recovery time calculation unit exceeds a time required to travel to the switching zone.

Here, in the case where the time calculated by the manual driving recovery time calculation unit exceeds the time required to travel from the current position to reach the predetermined switching zone, it is determined that the driver cannot cope with manual driving in the predetermined switching zone, and an alert is issued to ensure that a state in which the driver can cope with manual driving is achieved.

Here, as a method for alerting a driver, for example, it is conceivable that an alert tone is sounded to the driver, or alert display is performed on a monitor screen installed in front of the driver seat of the vehicle.

Accordingly, it is possible to prompt the driver to prepare to be able to cope with manual driving after the alert.

An automated driving assistance apparatus according to a fourth invention is the automated driving assistance apparatus according to the second or third invention, and further includes an automatic stop control unit that automatically stops the vehicle in a shelter area if a time calculated by the manual driving recovery time calculation unit exceeds a time required to travel to the switching zone.

Here, in the case where the time calculated by the manual driving recovery time calculation unit exceeds the time required to travel to reach the predetermined switching zone from the current position, it is determined that the driver cannot cope with manual driving in the predetermined switching zone, and the vehicle is automatically stopped in a shelter area.

Here, a shelter area refers to a zone in which safety can be ensured even when a vehicle is stopped, such as a roadside station, a side strip, or a parking area, a service area, or the like of a highway.

Accordingly, for example, when it is detected that the driver is sleeping, or the like, safety during automated driving can be ensured by determining that the driver cannot cope with manual driving, and automatically stopping the vehicle in a safe place temporarily.

An automated driving assistance apparatus according to a fifth invention is the automated driving assistance apparatus according to the first or second invention, and further includes a speed control unit that reduces a traveling speed of the vehicle for all or part of a distance to the switching zone during the automated driving, according to the level that has been set in a stepwise manner by the manual driving recovery level setting unit.

Here, control is performed so as to reduce the traveling speed of the vehicle that is being automatically driven for all or part of the distance to the switching zone, according to the level that has been set according to the above-described state of the driver, in order to secure a time required before the driver can cope with manual driving.

Here, for example, in the case where, when a vehicle is traveling on a highway at 90 km/h, the driver is in a forward focused state or a distracted state in which he or she can quickly cope with manual driving, deceleration control is not performed. Additionally, in the case of states such as operating a smartphone, eating/drinking, smoking, and reading in which manual driving can be coped with after a predetermined time has elapsed, the traveling speed is reduced to 75 km/h.

Accordingly, control for reducing the traveling speed makes it possible to secure a time required before manual driving can be recovered, and thus the driver can safely cope with manual driving before the predetermined switching zone is reached from the current position.

An automated driving assistance apparatus according to a sixth invention is the automated driving assistance apparatus according to the fifth invention, and further includes an alert generation unit that issues an alert to the driver in a case where a traveling speed that is reduced by the speed control unit is lower than a minimum speed.

Here, in the case where the traveling speed that is set by the above speed control unit is lower than the minimum speed that has been set for a highway or the like, it is determined that the driver cannot cope with manual driving in the predetermined switching zone, and an alert is issued to ensure that a state in which the driver can cope with manual driving is achieved.

Here, for example, it is conceivable that an alert tone is sounded to the driver, or alert display is displayed on a monitor screen installed in front of the driver seat of the vehicle as a method for giving an alert to the driver.

Accordingly, it is possible to prompt the driver to prepare so as to be able to cope with manual driving after the alert.

An automated driving assistance apparatus according to a seventh invention is the automated driving assistance apparatus according to the fifth or sixth invention, and further includes an automatic stop control unit that automatically stops the vehicle in a shelter area in a case where a traveling speed that is reduced by the speed control unit is lower than a minimum speed.

Here, in the case where the traveling speed that is set by the above speed control unit is lower than the minimum speed that has been set for a highway or the like, it is determined that the driver cannot cope with manual driving in the predetermined switching zone, and the vehicle is automatically stopped in a shelter area.

Here, a shelter area refers to a zone in which safety can be ensured even when a vehicle is stopped, such as a roadside station, a side strip, or a parking area, a service area, or the like of a highway.

Accordingly, for example, when it is detected that the driver is sleeping, or the like, safety during automated driving can be ensured by determining that manual driving cannot be coped with, and automatically stopping the vehicle in a safe place temporarily.

An automated driving assistance apparatus according to an eighth invention is the automated driving assistance apparatus according to any one of the first to seventh inventions, and the state of the driver that is detected by the driver monitoring unit includes one of a speed/size of movement, a direction of a line of sight, and an orientation/position of a face.

Here, information regarding the speed/size of movement of the driver, the direction of the line of sight, the orientation/position of the face, and the like is obtained as the state of the driver that is used for the above level setting that indicates whether or not manual driving can be recovered.

Here, these pieces of information regarding the driver can be obtained using a camera that can shoot the face of the driver in the front, a sensor attached to the driver, and the like. For example, the degree of arousal of the driver can be checked by detecting the orientation of the face of the driver, the direction and movement of the line of sight, and the like.

Accordingly, an appropriate level can be set according to the state of the driver.

An automated driving assistance apparatus according to a ninth invention is the automated driving assistance apparatus according to any one of the first to eighth inventions, and the driver monitoring unit detects the state of the driver using at least one of an image of the driver obtained by a camera installed in the vehicle and biological information of the driver that is obtained by a sensor.

Here, the state of the driver that is monitored by the driver monitoring unit is detected using an image captured by a camera that is installed, for example, in front of the driver seat, biological information obtained by a sensor attached to the driver, or the like.

Accordingly, for example, by detecting the state of the pupils of the driver, the number of blinks, the movement of the face, and the like using an image captured by the camera, it is possible to perform the above level setting indicating whether or not manual driving can be recovered. In addition, using biological information such as the driver's brain waves or heart rate obtained by a sensor or the like, level setting can be performed based on the state of the driver such as a sleeping state.

An automated driving assistance apparatus according to a tenth invention is an automated driving assistance apparatus for assisting automated driving control of a vehicle, and includes a driver monitoring unit and a manual driving recovery time calculation unit. The driver monitoring unit monitors a state of a driver that is driving the vehicle. The manual driving recovery time calculation unit calculates an estimated time required before the driver can cope with manual driving, based on the state of the driver detected by the driver monitoring unit.

Here, in the automated driving assistance apparatus that performs automated driving of a vehicle, the state of the driver of the vehicle during automated driving control is monitored, and a time required before a switch can be made from automated driving to manual driving is estimated based on the state of the driver.

Here, as the state of a driver that is monitored, a forward focused state or a distracted state in which manual driving can be quickly coped with, a smartphone operating state, an eating/drinking state, a smoking state, or a reading state in which manual driving can be coped with after a predetermined time has elapsed, or a sleeping state or the like in which there is a risk that manual driving cannot be coped with even after a predetermined time has elapsed is conceivable, for example. Additionally, such a state of a driver is monitored using an image captured by a camera installed in front of the driver or biological information (e.g., brain waves or heart rate) of the driver detected using a sensor of each of various types, for example.

In addition, for example, an estimated time is calculated as 2 to 3 seconds in the case of a forward focused state and a distracted state in which manual driving can be quickly coped with, and an estimated time is calculated as 5 to 10 seconds in the case of a smartphone operating state, an eating/drinking state, a smoking state, and a reading state in which manual driving can be coped with after a predetermined time has elapsed. Moreover, regarding a sleeping state and the like in which there is a risk that manual driving cannot be coped with even when a predetermined time has elapsed, for example, an estimated time of 3 minutes or more is set, or it suffices to set that recovering manual driving is impossible.

Accordingly, by estimating a time before manual driving can be recovered according to the state of the driver during automated driving, it is possible to easily determine whether or not there will be a problem if a switch is made from automated driving to manual driving in the predetermined switching zone.

Thus, for example, in the case where a recoverable time indicating a state where the driver cannot cope with manual driving quickly is estimated, it is possible to issue an alert (sound, display, etc.) prompting the driver to be able to cope with manual driving. Alternatively, if it is estimated that manual driving cannot be coped with even after a predetermined time has elapsed, it is possible to automatically stop the vehicle in a safe shelter area (e.g., a parking area, or a side strip) while continuing automated driving.

As a result, appropriate support can be provided according to the state of the driver, when switching from automated driving to manual driving.

An automated driving assistance system according to an eleventh invention includes the automated driving assistance apparatus according to any one of the first to tenth inventions, and a camera for capturing an image of the driver that is transmitted to the driver monitoring unit.

Here, the system is configured by including the above-described automated driving assistance apparatus and an imaging unit, such as a camera, installed around the driver seat.

Accordingly, as described above, appropriate support can be provided according to the state of the driver, when switching from automated driving to manual driving.

An automated driving assistance system according to a twelfth invention includes the automated driving assistance apparatus according to any one of the first to tenth inventions, and a sensor for obtaining biological information of the driver that is transmitted to the driver monitoring unit.

Here, the system is configured by including the above-described automated driving assistance apparatus and a sensor for obtaining biological information of the driver.

Accordingly, as described above, appropriate support can be provided according to the state of the driver, when switching from automated driving to manual driving.

An automated driving assistance method according to a thirteen invention is an automated driving assistance method for assisting automated driving control of a vehicle, and includes monitoring and setting. In the monitoring, a state of a driver that is driving the vehicle is monitored. In the setting, a level indicating whether or not a switch can be made from automated driving to manual driving in a predetermined switching zone is set in a stepwise manner based on the state of the driver detected in the monitoring.

Here, in the automated driving assistance method for performing automated driving of a vehicle, the state of the driver of the vehicle during automated driving control is monitored, and a level indicating whether or not a switch can be made from automated driving to manual driving is set in a stepwise manner according to the state of the driver.

Here, as the state of a driver that is monitored, a forward focused state or a distracted state in which manual driving can be quickly coped with, a smartphone operating state, an eating/drinking state, a smoking state, or a reading state in which manual driving can be coped with after a predetermined time has elapsed, or a sleeping state or the like in which there is a risk that manual driving cannot be coped with even after a predetermined time has elapsed is conceivable, for example. Such a state of a driver is then allocated to a level that has been set in a stepwise manner, using an image captured by a camera installed in front of the driver, or biological information (e.g., brain waves or heart rate) of the driver detected using a sensor of each of various types, for example.

In addition, the predetermined switching zone in which a switch is made from automated driving to manual driving refers to a zone that is automatically set at a position that is several kilometers before the exit of the IC closest to the destination when a vehicle is traveling on a highway, for example. Alternatively, in the case where information regarding traffic congestion, an accident, or the like is obtained while the vehicle is traveling, the predetermined switching zone may be a zone that is automatically set at a position that is several kilometers before the traffic congestion zone.

Accordingly, by setting a plurality of levels in a stepwise manner according to the state of the driver during automated driving, it is possible to easily determine whether or not there is a problem if a switch is made from automated driving to manual driving in the predetermined switching zone in the current state.

Thus, for example, it is possible to issue an alert (sound, display, etc.) for prompting a driver, for which a level indicating a state where manual driving cannot be quickly coped with has been set, to be able to cope with manual driving. Alternatively, regarding a driver for which a level indicating a state where manual driving cannot be coped with even when a predetermined time has elapsed has been set, it is possible to automatically stop the vehicle in a safe shelter area (e.g., a parking area or a side strip) while continuing automated driving control.

As a result, appropriate support can be provided according to the state of the driver, when switching from automated driving to manual driving.

An automated driving assistance program according to a fourteen invention is an automated driving assistance program for assisting automated driving control of a vehicle, and causes a computer to execute an automated driving assistance method that includes monitoring and setting. In the monitoring, a state of a driver that is driving the vehicle is monitored. In the setting, a level indicating whether or not a switch can be made from automated driving to manual driving in a predetermined switching zone is set in a stepwise manner based on the state of the driver detected in the monitoring.

Here, in the automated driving assistance program for performing automated driving of a vehicle, the state of the driver of the vehicle during automated driving control is monitored, and a level indicating whether or not a switch can be made from automated driving to manual driving is set in a stepwise manner according to the state of the driver.

Here, the state of the driver that is monitored refers to a forward focused state or a distracted state in which manual driving can be quickly coped with, a smartphone operating state, an eating/drinking state, a smoking state, or a reading state in which manual driving can be coped with after a predetermined time has elapsed, or a sleeping state or the like in which there is a risk that manual driving cannot be coped with even when a predetermined time has elapsed is conceivable, for example. Such a state of a driver is then allocated to a level that has been set in a stepwise manner using an image captured by a camera installed in front of the driver and biological information of the driver (e.g., brain waves or heart rate) detected using various types of sensors, for example.

In addition, the predetermined switching zone in which a switch is made from automated driving to manual driving refers to a zone that is automatically set at a position that is several kilometers before the exit of the IC closest to the destination when a vehicle is traveling on a highway, for example. Alternatively, in the case where information regarding traffic congestion, an accident, or the like is obtained during traveling, the predetermined switching zone may be a zone that is automatically set at a position that is several kilometers before the traffic congestion zone.

Accordingly, by setting a plurality of levels in a stepwise manner according to the state of the driver during automated driving, it is possible to easily determine whether or not there is a problem if a switch is made from automated driving to manual driving in the predetermined switching zone in the current state.

Thus, for example, it is possible to issue an alert (sound, display, etc.) for prompting a driver, for which a level indicating a state where manual driving cannot be quickly coped with has been set, to be able to cope with manual driving. Alternatively, regarding a driver for which a level indicating a state where manual driving cannot be coped with even when a predetermined time has elapsed has been set, it is possible to automatically stop the vehicle in a safe shelter area (e.g., a parking area or a side strip) while continuing automated driving control.

As a result, appropriate support can be provided according to the state of the driver, when switching from automated driving to manual driving.

An automated driving assistance method according to a fifteenth invention is an automated driving assistance method for assisting automated driving control of a vehicle, and includes monitoring and calculating. In the monitoring, a state of a driver that is driving the vehicle is monitored. In the calculating, a time that is taken for the driver to be able to cope with manual driving is estimated based on the state of the driver detected in the monitoring.

Here, in the automated driving assistance apparatus for performing automated driving of a vehicle, the state of a driver of the vehicle during automated driving control is monitored, and a time required before a switch from automated driving to manual driving can be made is estimated based on the state of the driver.

Here, as the state of a driver that is monitored, a forward focused state or a distracted state in which manual driving can be quickly coped with, a smartphone operating state, an eating/drinking state, a smoking state, or a reading state in which manual driving can be coped with after a predetermined time has elapsed, or a sleeping state or the like in which there is a risk that manual driving cannot be coped with even after a predetermined time has elapsed is conceivable, for example. Such a state of a driver is monitored using an image captured by a camera installed in front of the driver and biological information (e.g., brain waves and heart rate) of the driver detected using a sensor of each of various types, for example.

In addition, for example, an estimated time is calculated as 2 to 3 seconds in the case of a forward focused state and a distracted state in which manual driving can be quickly coped with, and 5 to 10 seconds in the case of a smartphone operating state, an eating/drinking state, a smoking state, and a reading state in which manual driving can be coped with after a predetermined time has elapsed. Moreover, regarding a sleeping state and the like in which there is a risk that manual driving cannot be coped with even after a predetermined time has elapsed, for example, an estimated time of 3 minutes or more is set, or it suffices to set that recovering manual driving is impossible.

Accordingly, by estimating a time before manual driving can be recovered according to the state of the driver during automated driving, it is possible to easily determine whether or not there is a problem if a switch is made from automated driving to manual driving in the predetermined switching zone.

Thus, for example, in the case where a recoverable time indicating a state where the driver cannot cope with manual driving quickly is estimated, it is possible to issue an alert (sound, display, etc.) for prompting the driver to be able to cope with manual driving. Alternatively, if it is estimated that manual driving cannot be coped with even after a predetermined time has elapsed, it is possible to automatically stop the vehicle in a safe shelter area (e.g., a parking area or a side strip) while continuing automated driving.

As a result, appropriate support can be provided according to the state of the driver, when switching from automated driving to manual driving.

An automated driving assistance program according to a sixteenth invention is an automated driving assistance program for assisting automated driving control of a vehicle, and causes a computer to execute an automated driving assistance method including monitoring and calculating. In the monitoring, a state of a driver that is driving the vehicle is monitored. In the calculating, a time before the driver can cope with manual driving is estimated based on the state of the driver detected in the monitoring.

Here, in the automated driving assistance apparatus for performing automated driving of a vehicle, the state of the driver of the vehicle during automated driving control is monitored, and a time required before a switch from automated driving to manual driving can be made is estimated based on the state of the driver.

Here, as the state of a driver that is monitored, for example, a forward focused state or a distracted state in which manual driving can be quickly coped with, a smartphone operating state, an eating/drinking state, a smoking state, or a reading state in which manual driving can be coped with after a predetermined time has elapsed, or a sleeping state or the like in which there is a risk that manual driving cannot be coped with even after a predetermined time has elapsed is conceivable. Such a state of a driver is monitored using an image captured by a camera installed in front of the driver and biological information (e.g., brain waves and heart rate) of the driver detected using a sensor of each of various types, for example.

In addition, for example, an estimated time is calculated as 2 to 3 seconds in the case of a forward focused state and a distracted state in which manual driving can be quickly coped with, and 5 to 10 seconds in the case of a smartphone operating state, an eating/drinking state, a smoking state, and a reading state in which manual driving can be coped with after a predetermined time has elapsed. Moreover, regarding a sleeping state and the like in which there is a risk that manual driving cannot be coped with even when a predetermined time has elapsed, for example, an estimated time of 3 minutes or more is set, or it suffices to set that recovering manual driving is impossible.

Accordingly, by estimating a time before it is possible to recover manual driving according to the state of the driver during automated driving, it is possible to easily determine whether or not there is a problem if a switch is made from automated driving to manual driving in predetermined switching zone.

Thus, for example, in the case where a recoverable time indicating a state where the driver cannot cope with manual driving quickly is estimated, it is possible to issue an alert (sound, display, etc.) for prompting the driver to be able to cope with manual driving. Alternatively, if it is estimated that manual driving cannot be coped with even when a predetermined time has elapsed, it is possible to automatically stop the vehicle in a safe shelter area (e.g., a parking area or a side strip) while continuing automated driving.

As a result, appropriate support can be provided according to state of driver, when switching from automated driving to manual driving.

### Effects of the Invention

According to the automated driving assistance apparatus according to the invention, appropriate support can be provided according to the state of the driver, when switching from automated driving to manual driving.

### BRIEF DESCRIPTION OF THE DRAWINGS

FIG. 1 is a diagram showing a switching zone, a control execution zone, checkpoints, and the like that are set on a highway on which a switch from automated driving to manual driving is made by an automated driving assistance apparatus according to an embodiment of the invention.

FIG. 2 is a control block diagram showing the configuration of an automated driving assistance apparatus according to an embodiment of the invention.

FIG. 3 is a diagram showing levels at which a driver can recover manual driving, the levels being set by the automated driving assistance apparatus in FIG. 2.

FIGS. 4(a) and 4(b) are diagrams for describing control when switching from automated driving to manual driving performed by the automated driving assistance apparatus in FIG. 2.

FIG. 5 is a flowchart showing a flow of switch control from automated driving to manual driving performed by the automated driving assistance apparatus in FIG. 2.

FIG. 6 is a control block diagram showing a configuration of an automated driving assistance apparatus according to another embodiment of the invention.

FIGS. 7(a) and 7(b) are diagrams for describing control when switching from automated driving to manual driving, the control being performed by the automated driving assistance apparatus in FIG. 6.

FIG. 8 is a flowchart showing a flow of switch control from automated driving to manual driving performed by the automated driving assistance apparatus in FIG. 6.

FIG. 9 is a control block diagram showing a configuration of an automated driving assistance apparatus according to yet another embodiment of the invention.

FIG. 10 is a control block diagram showing a configuration of an automated driving assistance apparatus according to yet another embodiment of the invention.

### EMBODIMENTS OF THE INVENTION

### First Embodiment

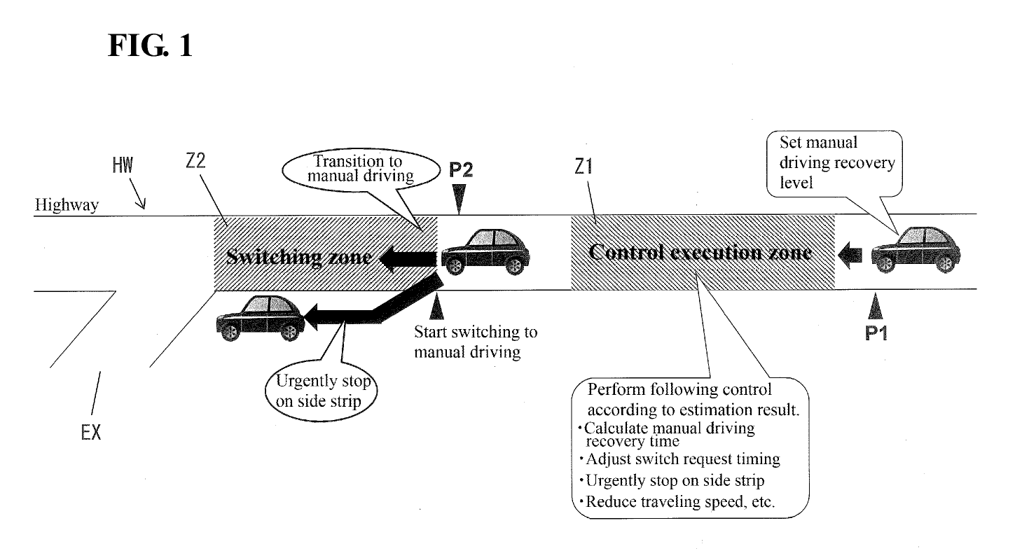

An automated driving assistance apparatus 10 according to an embodiment of the invention, an automated driving assistance system 50 provided with the automated driving assistance apparatus 10, and an automated driving assistance method will be described with reference to FIGS. 1 to 5 as follows.

For example, as shown in FIG. 1, the automated driving assistance system 50 according to this embodiment monitors the state of the driver of a passenger car (vehicle) 20 that is traveling on a highway HW through automated driving control, and outputs a manual driving recoverable level that is set in a stepwise manner according to the state of the driver. More specifically, the automated driving assistance system 50 of this embodiment monitors the state of the driver at a checkpoint P1 that has been set on the highway HW, determines whether or not a switch from automated driving to manual driving can be made in a predetermined switching zone Z2, and performs control required in a control execution zone Z1.

In this embodiment, the control execution zone Z1 and the switching zone Z2 are set based on information regarding a destination that has been input to a navigation apparatus 21 mounted in the passenger car 20 to be described later and an interchange (IC) closest to the destination, map information, and the current position information of the passenger car 20 obtained using a GPS (Global Positioning System).

Here, the above control execution zone Z1 refers to a zone having a length of several kilometers in which control for assisting a switch to manual driving is performed according to the state of the driver to be described later. The control execution zone Z1 is set at a point that is several kilometers before the switching zone Z2 that is set from destination information. The checkpoint P1 is then set at a position that is immediately before (the passenger car 20 moves into) the control execution zone Z1.

Moreover, the above switching zone Z2 refers to a zone having a length of several kilometers that is set between the above control execution zone Z1 and the IC exit EX, and in which switch control from automated driving to manual driving is performed. The switching zone Z2 is set at a point that is several kilometers before the IC exit EX that is set from destination information. A re-check point P2 is then set at a position immediately before (the passenger car 20 moves into) the switching zone Z2.

Note that the lengths of the control execution zone Z1 and the switching zone Z2 are adjusted according to the traveling speed of the road on which the passenger car 20 is traveling. For example, as in this embodiment, in the case of performing switch control on the highway HW, a traveling speed during automated driving control is estimated to be 80 to 100 km/h, and thus the lengths of the control execution zone Z1 and the switching zone Z2 are set to have a length of 1 to 3 km, for example.

On the other hand, in the case of performing switch control on a public road, a traveling speed during automated driving control is estimated to be 30 to 60 km/h, and thus, the lengths of the control execution zone Z1 and the switching zone Z2 are set to have a length of several hundreds of meters to 1 km, for example.

In addition, contents of control that is performed in the control execution zone Z1 include announcement of a switch request (alert), reduction in the traveling speed, urgent stopping on a side strip, and the like, such that a switch to manual driving can be made in the switching zone Z2 in a safe state according to the state of the driver.

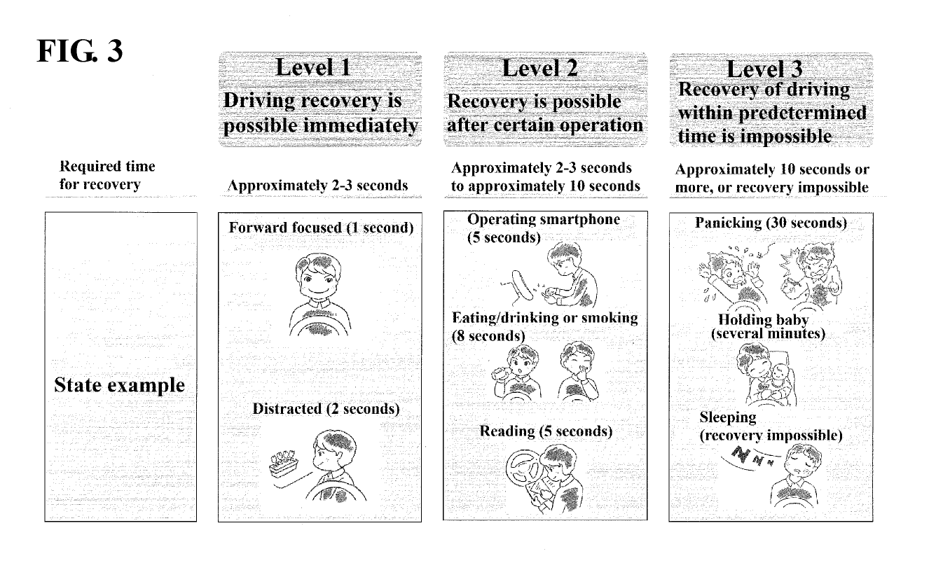

The checkpoint P1 is installed immediately before the control execution zone Z1, and in order to determine contents of control for assisting a switch, which is performed in the control execution zone Z1, and will be described later, manual driving recovery levels 1 to 3 (see FIG. 3) classified in a stepwise manner are set based on the state of the driver.

The re-check point P2 is installed immediately before the switching zone Z2, and the state of the driver is checked again in order to finally check whether or not the driver can cope with a switch from automated driving to manual driving that is made in the switching zone Z2.

In this embodiment, control for adjusting switch request timing and control for urgent stopping on a side strip from among the above contents of control in the control execution zone Z1 will be described below.

Automated Driving Assistance System 50

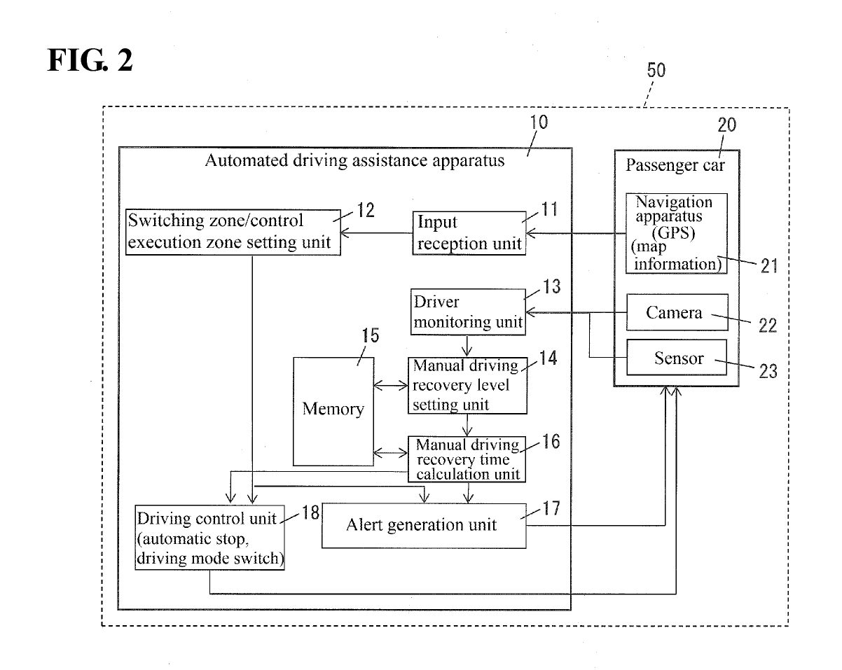

The automated driving assistance system 50 of this embodiment includes the automated driving assistance apparatus 10 and the passenger car 20 as shown in FIG. 2.

The automated driving assistance apparatus 10 is incorporated in a camera 22 or the like mounted in the passenger car 20, for example, and monitors the state of the driver during automated driving, and outputs a state indicating whether or not a switch to manual driving can be made, in multiple degrees, according to the state of the driver. Note that the configuration of the automated driving assistance apparatus 10 will be described below in detail.

The passenger car 20 is equipped with a system that enables traveling through automated driving control, and is provided with the navigation apparatus 21, the camera (imaging unit) 22, and a sensor 23 as shown in FIG. 2.

The navigation apparatus 21 is an electronic device that stores map information, and provides electronic route guidance to a destination using current position information obtained by a GPS and the map information, and information regarding the destination has been input to the navigation apparatus 21 by the driver or the like.

Note that, in the automated driving assistance system 50 of this embodiment, the switching zone Z2, the control execution zone Z1, and the like that are set before an IC closest to a destination are set using information regarding the destination that has been input to the navigation apparatus 21, map information stored in the navigation apparatus 21, current position information obtained by the GPS, and the like (see FIG. 1).

The camera 22 is installed at a position at which the face of the driver of the passenger car 20 can be shot from the front, for example, and shoots an image (including a video image) for monitoring the state of the driver of the passenger car 20. An image captured by the camera 22 is subjected to image processing in order to recognize the state of the driver such as the orientation/position of the face of the driver, the direction of the line of sight, the position of the pupils, the speed of movement, and the like.

The sensor 23 is provided in order to obtain biological information of the driver, such as the driver's brain waves and heart rate.

In the automated driving assistance system 50 of this embodiment, as shown in FIG. 2, information of an image captured by the camera 22 and a detection result by the sensor 23 are each transmitted to a driver monitoring unit 13 of the automated driving assistance apparatus 10.

Automated Driving Assistance Apparatus 10

As shown in FIG. 2, the automated driving assistance apparatus 10 has an input reception unit 11, a switching zone/control execution zone setting unit 12, the driver monitoring unit 13, a manual driving recovery level setting unit 14, a memory 15, a manual driving recovery time calculation unit 16, an alert generation unit 17, and a driving control unit (automatic stop control unit) 18.

The input reception unit 11 is connected to the navigation apparatus 21 mounted in the passenger car 20 via wired or wireless communication as shown in FIG. 2, and mainly obtains information regarding a destination that has been input by the driver or the like. In addition, the input reception unit 11 obtains map information from the navigation apparatus 21 and the current position information of the passenger car 20, and transmits the information for setting the IC closest to the destination, the switching zone Z2 that is set before the IC, and the like, to the switching zone/control execution zone setting unit 12.

The switching zone/control execution zone setting unit 12 sets the switching zone Z2 at a position that is several kilometers before the IC exit EX of the highway HW shown in FIG. 1, based on the destination information obtained from the navigation apparatus 21 of the passenger car 20 via the input reception unit 11. The switching zone/control execution zone setting unit 12 also sets the control execution zone Z1 at a position that is several kilometers before the switching zone Z2 as shown in FIG. 1.

Note that the switching zone/control execution zone setting unit 12 additionally sets the checkpoint P1 and the re-check point P2 respectively before the control execution zone Z1 and the switching zone Z2 that have been set.

The switching zone/control execution zone setting unit 12 then transmits information regarding the control execution zone Z1, the switching zone Z2, the checkpoint P1, and the re-check point P2 to the alert generation unit 17 and the driving control unit 18 as shown in FIG. 2.

The driver monitoring unit 13 obtains an image captured by the camera 22 and a detection result by the sensor 23 respectively from the camera 22 and the sensor 23 that are mounted in the passenger car 20, as shown in FIG. 2. Accordingly, the driver monitoring unit 13 monitors the state of the driver using the image captured by the camera 22 and the biological information of the driver obtained from the sensor 23.

Specifically, the driver monitoring unit 13 detects the position, orientation, and movement of the face of the driver, the direction of the line of sight, the position of the pupils, movement of the body, and the like, using the image captured by the camera 22. The driver monitoring unit 13 also obtains the biological information including data such as the driver's brain waves and heart rate from the sensor 23.

The driver monitoring unit 13 then transmits information regarding the state of the driver that has been detected using the image and the biological information, to the manual driving recovery level setting unit 14.

The manual driving recovery level setting unit 14 obtains, from the driver monitoring unit 13, the information regarding the state of the driver of the passenger car 20 during automated driving as shown in FIG. 2, and sets a manual driving recoverable level having been classified in a stepwise manner.

Specifically, as shown in FIG. 3, the manual driving recovery level setting unit 14 classifies the state of the driver detected by the driver monitoring unit 13 into Levels 1 to 3 that are set in a stepwise manner as indexes indicating whether or not the driver can cope with a switch from automated driving to manual driving.

For example, if it is determined based on an image captured by the camera 22 and a detection result by the sensor 23 that the driver is forward-focused or is distracted, for example, watching the scenery while traveling, Level 1 is set.

Level 1 refers to a state where the driver can cope with a switch from automated driving to manual driving in a short time of about 1 to 3 seconds.

Here, in order to determine that a driver is forward-focused, for example, the orientation of the face of the driver and the direction of the line of sight are detected using an image captured by the camera 22, and a condition for the determination is that it is detected from biological information obtained by the sensor 23 that the degree of arousal of the driver is high. Also, conditions for determining that a driver is distracted are that it is detected using an image captured by the camera 22 that the orientation of the face of the driver and the direction of the line of sight are directions other than the forward direction, and it is detected from biological information obtained by the sensor 23 that the degree of arousal of the driver is high, for example.

In addition, if it is determined based on an image captured by the camera 22 and a detection result by the sensor 23 that the driver is operating a smartphone, eating/drinking, smoking, or reading, Level 2 is determined.

Level 2 refers to a state where the driver can cope with a switch from automated driving to manual driving in a time of about 3 to 8 seconds during which a certain operation is performed.

Here, conditions for determining that the driver is operating a smartphone are that it is detected, using an image captured by the camera 22, that the orientation of the face of the driver and the direction of the line of sight are downward, and it is detected from biological information obtained by the sensor 23 that the degree of arousal of the driver is high, for example. Also, conditions for determining that the driver is eating/drinking or smoking are that it is detected, using an image captured by the camera 22, that the orientation of the face of the driver and the direction of the line of sight change in a short time, and it is detected from biological information obtained by the sensor 23 that the degree of arousal of the driver is high, for example. Furthermore, conditions for determining that a driver is reading are that it is detected, using an image captured by the camera 22, that the orientation of the face of the driver and the direction of the line of sight are downward, and it is detected from biological information obtained by the sensor 23 that the degree of arousal of the driver is high, for example.

In addition, if it is determined that a driver is panicking, holding a baby, or sleeping, Level 3 is determined based on an image captured by the camera 22 and a detection result by the sensor 23.

Level 3 refers to a state where the driver can cope with a switch from automated driving to manual driving in a predetermined time of 10 seconds or more. Alternatively, Level 3 refers to a state where manual driving cannot be coped with even when a predetermined time has elapsed.

Here, in order to determine that a driver is panicking, for example, movement of the face of the driver, the speed of movement, and the like are detected using an image captured by the camera 22, and a condition for the determination is that it is detected from biological information obtained by the sensor 23 that the degree of arousal of the driver is high. Moreover, conditions for determining that the driver is holding a baby is that a face of a person other than the driver is detected using an image captured by the camera 22, and it is detected from biological information obtained by the sensor 23 that the degree of arousal of the driver is high, for example. Furthermore, in order to determine that a driver is sleeping, the line of sight of the driver, the position of the pupils, the opening degree of eye lids, and the like are detected using an image captured by the camera 22, and a condition for the determination is that it is detected from biological information obtained by the sensor 23 that the degree of arousal of the driver is low, for example.

The levels that have been set by the manual driving recovery level setting unit 14 are stored in the memory 15, and are transmitted to the manual driving recovery time calculation unit 16.

The memory 15 stores levels that have been set by the manual driving recovery level setting unit 14, and stores, in advance, a table (see FIG. 3) used for determining which level the state of a driver detected by the driver monitoring unit 13 corresponds to.

Accordingly, when information regarding the state of a driver detected by the driver monitoring unit 13 is obtained, the manual driving recovery level setting unit 14 can easily determine which level the state of the driver correspond to, by referencing the table stored in the memory 15.

The manual driving recovery time calculation unit 16 obtains a result of level determination of the state of the driver from the manual driving recovery level setting unit 14, and calculates an estimated time indicating how much time it takes for the driver to be able to cope with manual driving, based on the level.

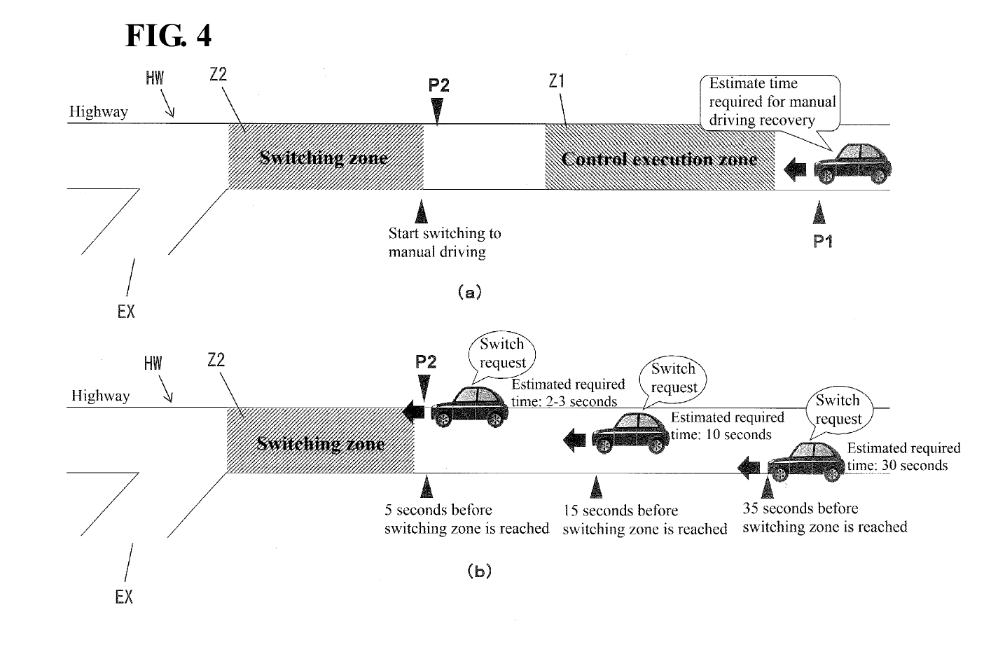

Specifically, the manual driving recovery time calculation unit 16 calculates an estimated time before it is possible to recover manual driving at the checkpoint P1, using the table shown in FIG. 3 that is stored in the memory 15 in advance, according to the result of level determination indicating the state of the driver, as shown in FIG. 4(a).

Specifically, in the case where a determination result by the manual driving recovery level setting unit 14 is Level 1, the manual driving recovery time calculation unit 16 estimates a required time for recovery as 1 to 3 seconds, by referencing the table shown in FIG. 3 that is stored in the memory 15 in advance. Similarly, in the case where a determination result by the manual driving recovery level setting unit 14 is Level 2, the manual driving recovery time calculation unit 16 estimates a required time for recovery as 3 to 10 seconds. Similarly, in the case where a determination result by the manual driving recovery level setting unit 14 is Level 3, the manual driving recovery time calculation unit 16 estimates a required time for recovery as 10 seconds to several minutes, or determines that manual driving cannot be recovered.

Note that a plurality of required time periods for recovery may be set for each of the levels 1 to 3 as shown in FIG. 3, and a required time period for recovery may be estimated using a table in which states of a driver are classified into a larger number of levels respectively corresponding to required time periods for recovery.

The alert generation unit 17 issues an alert at a predetermined timing corresponding to each level indicating the state of the driver, in the passenger car 20 that is traveling in the control execution zone Z1 that has been set by the switching zone/control execution zone setting unit 12.

Specifically, the alert generation unit 17 announces a switch request at a predetermined timing, using the navigation apparatus 21 of the passenger car 20 that is traveling in the control execution zone Z1 through automated driving control.

Note that announcement of a switch request refers to announcement for informing the driver of the passenger car 20 traveling through automated driving that a switch from automated driving to manual driving is to be made. Thus, announcement of a switch request is performed before the switching zone Z2 is entered. In addition, announcement of a switch request may be output as sound information through a speaker mounted in the passenger car 20, or may be output as text information through a monitor screen of the navigation apparatus 21, for example.

For example, if a determination result by the manual driving recovery level setting unit 14 is Level 1, the driver can cope with manual driving in 1 to 3 seconds. Thus, the alert generation unit 17 controls the navigation apparatus 21 to announce a switch request five seconds before the switching zone Z2 is entered, as shown in FIG. 4(b).

In the case where a determination result by the manual driving recovery level setting unit 14 is Level 2, the driver can cope with manual driving in 3 to 10 seconds. Thus, as shown in FIG. 4(b), the alert generation unit 17 controls the navigation apparatus 21 or a speaker mounted in the passenger car 20 to announce a switch request 15 seconds before the switching zone Z2 is entered.

In addition, in the case where a determination result by the manual driving recovery level setting unit 14 is Level 3, and it is not determined that manual driving cannot be recovered, the driver can cope with manual driving in 10 to 30 seconds. Thus, as shown in FIG. 4(b), the alert generation unit 17 controls the navigation apparatus 21 to announce a switch request, for example, 35 seconds before the switching zone Z2 is entered, according to the state of the driver.

The driving control unit (automatic stop control unit) 18 switches the driving mode from an automated driving control mode to a manual driving mode, and from the manual driving mode to the automated driving mode. The driving control unit 18 also controls the passenger car 20 to switch from automated driving to manual driving, or stop on a side strip, according to the state of the driver during automated driving.

Specifically, after a switch request is announced in the control execution zone Z1 at a predetermined timing, a final check of the state of the driver is performed at the re-check point P2 and if it is determined that there is no problem, the driving control unit 18 switches the passenger car 20 from automated driving to manual driving.

In a switch from automated driving to manual driving, automatic control of a steering-wheel operation, an accelerator operation, and the like is cancelled, and those operations are switched to manual operation that is performed by the driver.

On the other hand, if a determination result by the manual driving recovery level setting unit 14 is Level 3, and it is determined that manual driving cannot be recovered, the driving control unit 18 automatically stops the passenger car 20 in a shelter area without canceling automated driving control, as shown in FIG. 1.

Here, as a shelter area, a side strip of a road on which the vehicle is traveling, or the like as shown in FIG. 1 is conceivable, for example.

Accordingly, in the passenger car 20 that is being automatically driven, if it is determined that manual driving cannot be recovered, for example, when the driver is sleeping, switch control to manual driving is not performed in the switching zone Z2, and the passenger car 20 can be stopped in a safe place.

Flow of Automated Driving Assistance Method

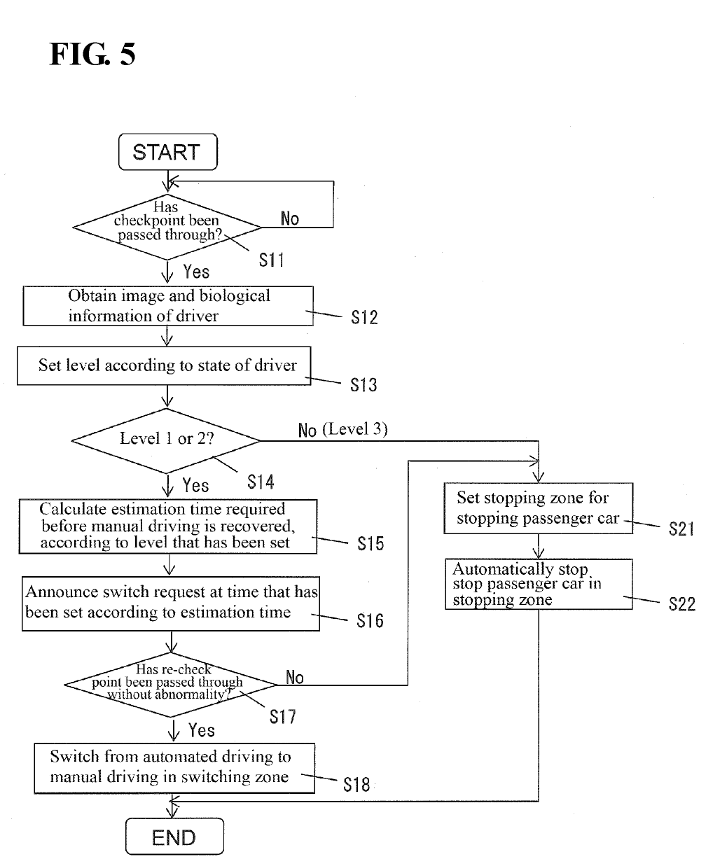

In the automated driving assistance system 50 of this embodiment, an automated driving assistance method is executed in accordance with the flowchart shown in FIG. 5 due to the above-described configuration.

Accordingly, as shown in FIG. 5, it is determined in step S11 whether or not the checkpoint P1 that is set immediately before the control execution zone Z1 has been passed through, and if the checkpoints P1 has been passed through, the procedure advances to step S12.

Next, in step S12, the driver monitoring unit 13 obtains an image of a driver captured by the camera 22 mounted in the passenger car 20, and biological information of the driver as a detection result by the sensor 23.

Next, in step S13, the manual driving recovery level setting unit 14 sets a level classified in a stepwise manner, according to the state of the driver obtained from the driver monitoring unit 13.

Next, in step S14, it is determined whether the state of the driver determined by the manual driving recovery level setting unit 14 is Level 1 or Level 2.

Here, in the case where Level 1 or Level 2 is determined, the procedure advances to step S15. On the other hand, if Level 3 is determined, it is envisioned that a switch to manual driving cannot be made smoothly since the driver is sleeping or the like, and thus the procedure advances to step S21.

Note that, in the flowchart shown in FIG. 5, a flow is set in which the procedure advances to step S21 without exception in the case of Level 3, but, as described above, even in the case of Level 3, if the driver can recover manual driving after a predetermined time has elapsed, the procedure may advance to step S15.

Next, in step S15, the manual driving recovery time calculation unit 16 calculates an estimated time required before the driver can cope with manual driving, according to the level determined by the manual driving recovery level setting unit 14. Note that this estimated time is calculated by referencing the table stored in the memory 15 in advance (see FIG. 3) as described above.

Next, in step S16, the alert generation unit 17 announces a switch request using a speaker mounted in the passenger car 20, or the like, at a time that has been set according to the estimated time calculated in step S15.

Specifically, if manual driving can be quickly coped with as the state of the driver, announcement of a switch request is performed several seconds before the passenger car 20 enters the switching zone Z2. On the other hand, if it takes a predetermined time to cope with manual driving, announcement of a switch request is performed 15 to 35 seconds before the passenger car 20 enters the switching zone Z2 (see FIG. 4(b)), for example.

Next, in step S17, it is determined whether or not the re-check point P2 has been passed through, and if the re-check point P2 has been passed through, the procedure advances to step S18.

Next, in step S18, after announcement of a switch request is performed in the control execution zone Z1 at an appropriate timing, a final check is performed at the re-check point P2. Therefore, the driving control unit 18 determines that a switch of the passenger car 20 from automated driving to manual driving can be made, and performs switch control.

Accordingly, by classifying the state of the driver of the passenger car 20 during automated driving into stepwise manner, performing detection, and taking an appropriate measurement for each level, switch control from automated driving to manual driving can be performed while ensuring safety.

On the other hand, in step S21, Level 3 including a state where the driver is sleeping was determined in step S14, and thus a shelter area required for safely stopping the passenger car 20 is set. The shelter area includes a side strip or the like of the road on which the passenger car is traveling.

Next, in step S22, the passenger car 20 is automatically stopped in the shelter area that was set in step S21.

Accordingly, if it is determined in step S14 that the driver cannot cope with manual driving (Level 3), it is possible to give up a switch from automated driving to manual driving, and stop the passenger car 20 in a safe place.

### Second Embodiment

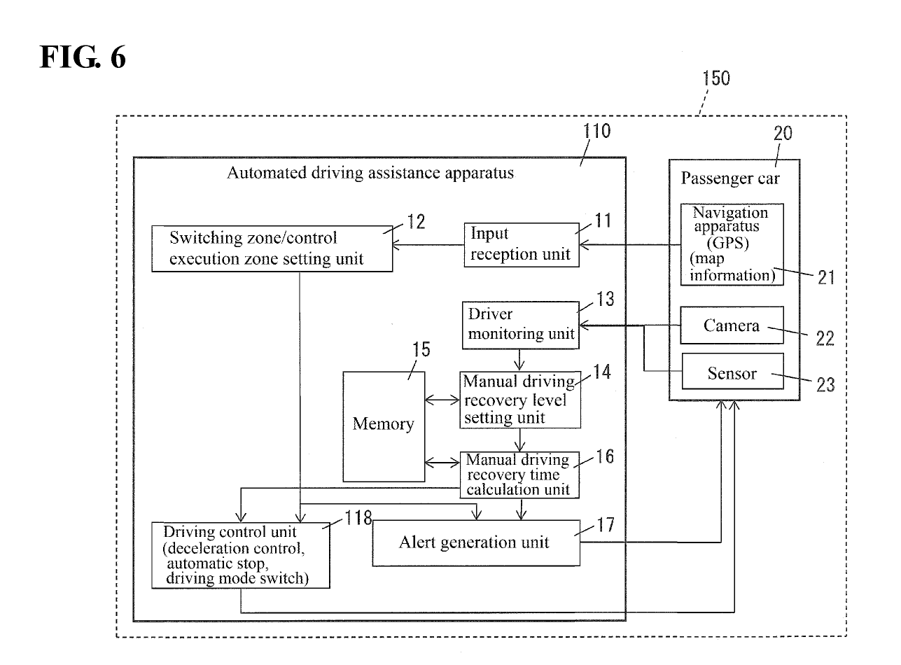

An automated driving assistance apparatus 110 according to another embodiment of the invention will be described with reference to FIGS. 6 to 8 as follows.

Note that this embodiment is different from the above first embodiment in that the state of a driver during automated driving is monitored, and a time before the driver copes with manual driving is secured by reducing the traveling speed of a passenger car 20 for all or part of a distance before a switching zone Z2 is entered, according to levels that have been set in a stepwise manner according to the state of the driver.

Other configurations are similar to the above first embodiment, and thus the same reference numerals are given to configurations that have similar functions to the configurations described in the first embodiment, and a description thereof is omitted.

In this embodiment, among the above control contents in the control execution zone Z1, control for reducing the traveling speed of the passenger car 20 according to the state of a driver in order to sufficiently secure a time before the passenger car 20 that is being automatically driven reaches the switching zone Z2 will be described below.

In an automated driving assistance system 150 (an automated driving assistance apparatus 110) according to this embodiment, as shown in FIG. 6, the automated driving assistance apparatus 110 includes a driving control unit 118 that performs control so as to reduce the traveling speed of the passenger car 20 in the control execution zone Z1.

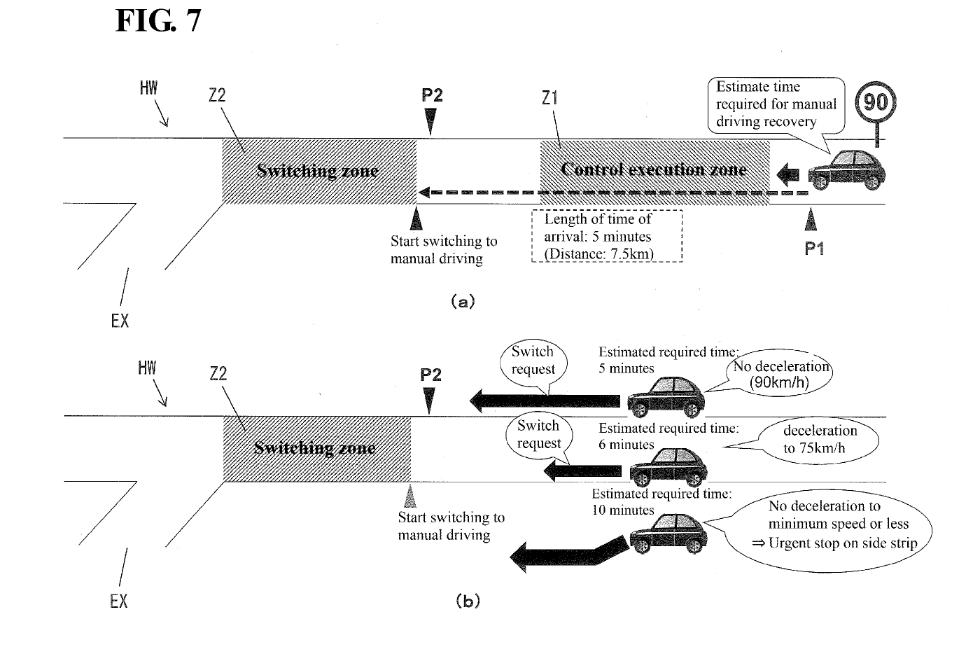

As shown in FIG. 7(a), the driving control unit 118 performs control so as to reduce the traveling speed of the passenger car 20 in the control execution zone Z1 based on a level that has been set according to the state of the driver of the passenger car 20 that is traveling on a highway whose speed limit is 90 km/h.

Here, in the example shown in FIG. 7(a), a state is envisioned in which a passenger car is traveling through automated driving at 90 km/h that is the same as the speed limit, and the remaining distance from a checkpoint P1 to the switching zone Z2 is 7.5 km, and the checkpoint P1 will be reached in 5 minutes.

Specifically, using an image shot by a camera 22 and a detection result by a sensor 23 obtained by the driver monitoring unit 13, the driving control unit 118 reduces the traveling speed of the passenger car 20 so as to extend a time before the passenger car 20 enters the switching zone Z2, based on the level 1 to 3 that was set by a manual driving recovery level setting unit 14.

For example, in the case where a determination result by the manual driving recovery level setting unit 14 is Level 1, the driver can cope with manual driving in 1 to 3 seconds. Therefore, the driving control unit 118 determines that there is no problem if a time before the switching zone Z2 is entered is 5 minutes as it is, as shown in FIG. 7(b), and controls the accelerator position of the passenger car 20 to keep traveling without reducing the speed.

In the case where a determination result by the manual driving recovery level setting unit 14 is Level 2, the driver can cope with manual driving when a predetermined time has elapsed. Thus, the driving control unit 118 controls the accelerator position of the passenger car 20 such that the traveling speed of the passenger car 20 changes from 90 km/h to 75 km/h so as to extend a time before the switching zone Z2 is entered from 5 minutes to 6 minutes, as shown in FIG. 7(b).

Accordingly, although the driver cannot quickly cope with manual driving, it is possible to extend a time before the switching zone Z2 is entered by 1 minute from 5 minutes to 6 minutes, and thus it is possible secure a sufficient time before manual driving can be coped with.

In addition, if a determination result by the manual driving recovery level setting unit 14 is Level 3, and it is determined that manual driving cannot be coped with in several seconds, a time of 10 minutes or more is required, for example. Thus, the driving control unit 118 first calculates a traveling speed for securing 10 minutes before the passenger car 20 enters the switching zone Z2, and in the case where the traveling speed is lower than or equal to the minimum speed (for example, 60 km/h) of the highway HW on which the passenger car 20 is traveling, stops the passenger car 20.

Accordingly, in the case where the traveling speed (45 km/h) as a result of deceleration for securing a sufficient time (e.g., 10 minutes) for the driver of the passenger car 20 to be able to switch to manual driving is lower than the minimum speed (60 km/h) of the highway HW on which the passenger car 20 is traveling, automated driving is continued, and the passenger car 20 is urgently stopped on a side strip as shown in FIG. 7(b).

Accordingly, even when a passenger car is traveling on a road on which the minimum speed is set, such as the highway HW, it is possible to prevent the passenger car 20 from traveling through automated driving in the state where the traveling speed is reduced to be lower than the minimum speed.

Flow of Automated Driving Assistance Method

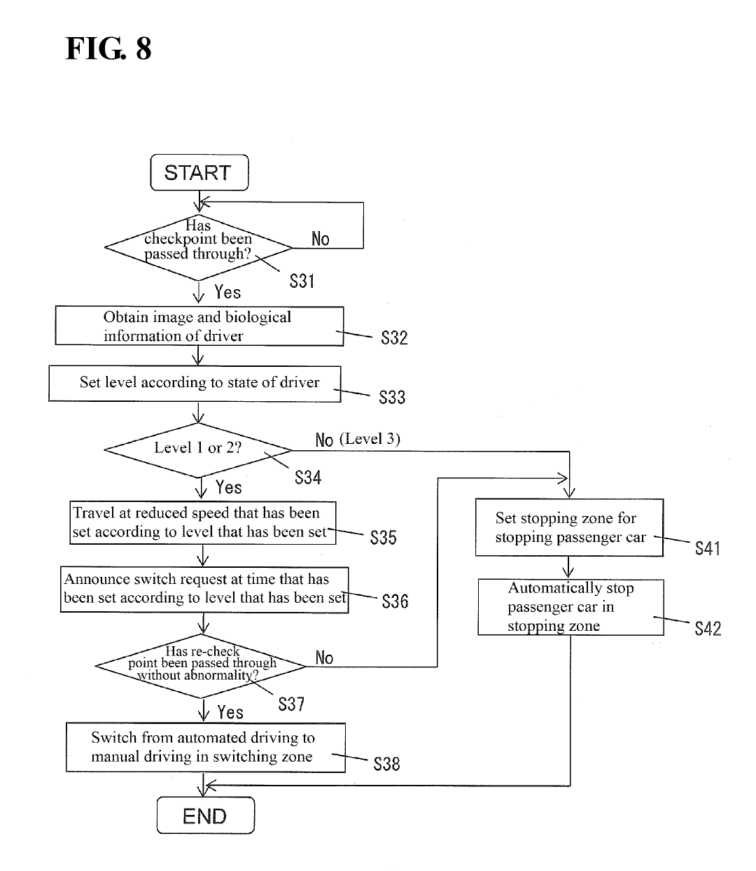

In the automated driving assistance system 150 of this embodiment, due to configuration as described above, an automated driving assistance method is executed in accordance with the flowchart shown in FIG. 8.

Note that steps S31 to S34 are similar to steps S11 to S14 in the flowchart shown in FIG. 5 and described in the above first embodiment, and thus a description thereof is omitted here.

Next, in step S35, the traveling speed of the passenger car 20 is reduced according to a level determined by the manual driving recovery level setting unit 14 in order to secure a sufficient time required before the driver can cope with manual driving. Note that this deceleration speed is set based on the distance between the checkpoint P1 and the switching zone Z2, the current traveling speed of the passenger car 20, a time calculated by the manual driving recovery time calculation unit 16, and the like.

Next, in step S36, announcement of a switch request is performed at a time that has been set according to the level that has been set by the manual driving recovery level setting unit 14. This announcement of a switch request is performed using a speaker mounted in the passenger car 20 or the like, similar to the above first embodiment.

Note that, in this embodiment, deceleration control is performed in order to secure a sufficient time to be able to cope with a switch to manual driving, and thus a switch request for informing the driver of a switch to manual driving may be announced at the position at a predetermined distance before the switching zone Z2 without exception.

Next, in step S37, when the re-check point P2 is passed through, a final check of the driver is performed, and the above presence or absence is determined.

Here, if it is determined that the driver is prepared to cope with manual driving when the re-check point P2 is passed through, it is determined that there is no abnormality, and the procedure advances to step S38. On the other hand, if it is determined that the driver cannot cope with manual driving yet, it is determined that there is an abnormality, and the procedure advances to step S41.

Next, after announcement of a switch request is performed in the control execution zone Z1 at an appropriate timing in step S38, a final check is performed in the re-check point P2. Therefore, the driving control unit 118 determines that a switch of the passenger car 20 from automated driving to manual driving can be made, and performs switch control.

Accordingly, by classifying the state of the driver of the passenger car 20 that is being automatically driven in a stepwise manner and performing detection, and taking an appropriate measurement for each level, switch control from automated driving to manual driving can be performed while ensuring safety.

On the other hand, in step S41, Level 3 that that includes a state where the driver is sleeping is determined in step S34, or it is determined in step S37 that the driver cannot cope with manual driving yet. Therefore, in such a state of the driver, unless the traveling speed is reduced to the minimum speed, a time for coping with manual driving cannot be secured. Thus, it is determined that a switch to automated driving cannot be made, and a shelter area required for safely stopping the passenger car 20 is set. The shelter area includes a side strip or the like of the road on which the passenger car 20 is traveling.

Next, in step S42, the passenger car 20 is automatically stopped in the shelter area that was set in step S41.

Accordingly, in step S34, in the case where it is determined that the traveling speed needs to be reduced to be lower than the minimum speed of the road on which the passenger car 20 is traveling in order for the driver to cope with manual driving (Level 3), it is possible to give up the switch from automated driving to manual driving and stop the passenger car 20 in a safe place.

### Other Embodiments

Embodiments of the invention has been described above, but the invention is not limited to the above embodiment, and various modifications can be made without departing from the gist of the invention.

### (A)

In the above first embodiment, description has been given with an example in which the automated driving assistance apparatus 10 includes the manual driving recovery level setting unit 14 that sets, in a stepwise manner, levels indicating whether or not a switch can be made from automated driving to manual driving in a predetermined switching zone, based on the state of the driver. However, the invention is not limited thereto.

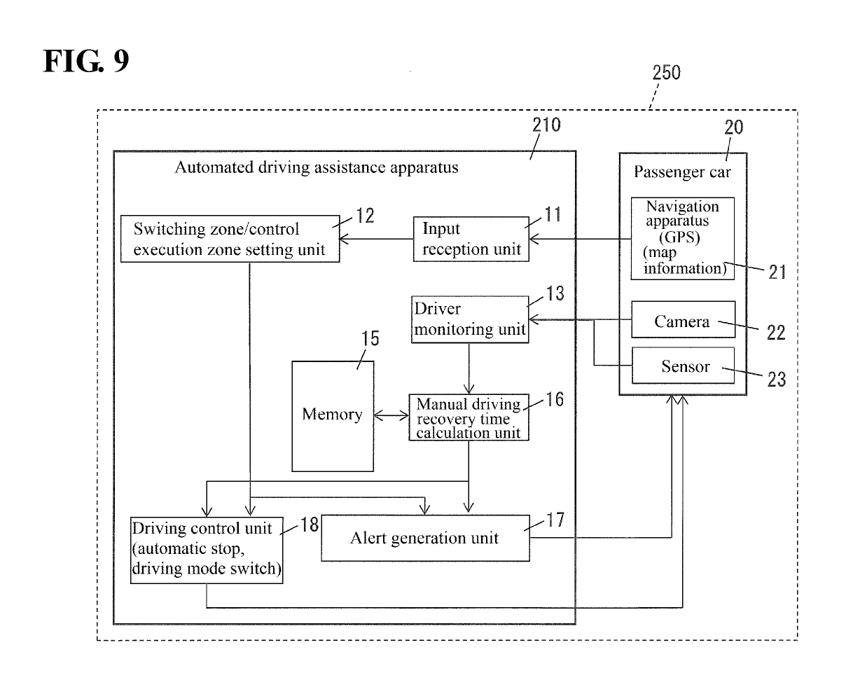

For example, as shown in FIG. 9, an automated driving assistance apparatus 210 that does not include a manual driving recovery level setting unit, and an automated driving assistance system 250 that includes the automated driving assistance apparatus 210 may be used.

In this case, it is sufficient that the manual driving recovery time calculation unit 16 calculates a time required for the driver of the passenger car that is being automatically driven to be able to cope with manual driving, based on the state of the driver detected by the driver monitoring unit 13.

Accordingly, the alert generation unit 17 and the driving control unit 18 can respectively control a timing when an alert is issued and a timing when announcement of a switch request when switching from automated driving to manual driving is performed, according to the length of the time calculated by the manual driving recovery time calculation unit 16.

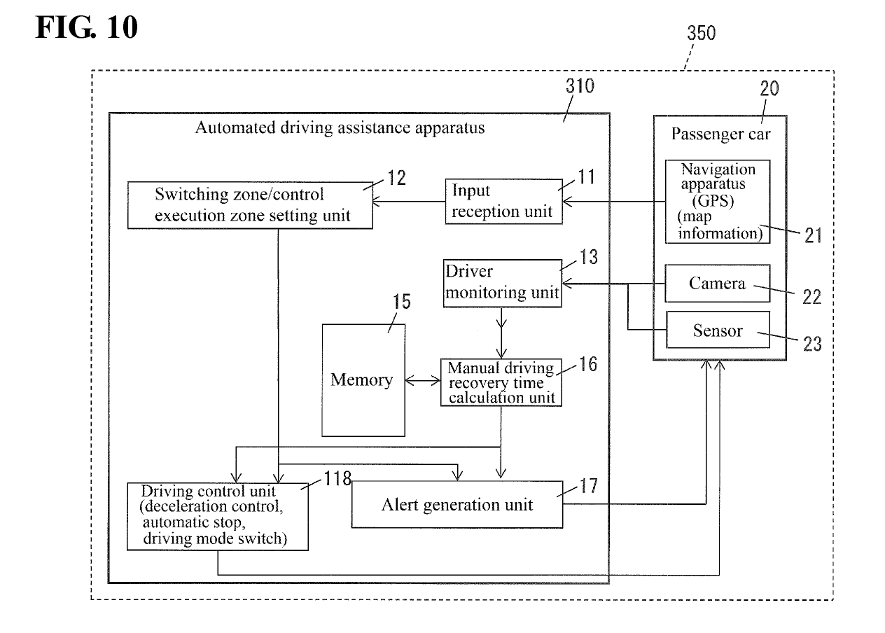

Note that, regarding the configuration of the second embodiment, as shown in FIG. 10, an automated driving assistance apparatus 310 that does not have a manual driving recovery level setting unit and an automated driving assistance system 350 that includes the automated driving assistance apparatus 310 may be used similarly.

### (B)

In the above first and second embodiments, as the automated driving assistance methods according to the invention, methods that are executed in accordance with the flowcharts shown in FIGS. 5 and 8 have been described as an example. However, the invention is not limited thereto.

For example, the invention may be achieved as an automated driving assistance program that causes a computer to execute the automated driving assistance methods that are executed in accordance with the flowcharts shown in FIGS. 5 and 8.

In addition, the invention may be achieved as a recording medium that stores this automated driving assistance program.

### (C)

In the above first and second embodiments, description has been given with an example in which an estimated time before the driver of the passenger car 20 that is being automatically driven can cope with manual driving is calculated. However, the invention is not limited thereto.

In the invention, it is not necessary to calculate an estimated time before a driver during automated driving can cope with manual driving, and for example, it suffices to perform control so as to issue an alert, automatically stop the passenger car in a shelter area, reduce the traveling speed, and the like, according to a level that have been set by the manual driving recovery level setting unit.

### (D)

In the above first and second embodiments, description has been given with an example in which a switch to manual driving is made while the passenger car 20 that is being automatically driven is traveling on the highway HW. However, the invention is not limited thereto.

The invention is not limited to a vehicle that is traveling on a highway, and the invention may be applied as control when switching a vehicle that is traveling on a road other than a highway such as a public road, a vehicle-only road, or the like, to manual driving through automated driving control.

### (E)

In the above first and second embodiments, description has been given with an example in which a switching zone for switching from automated driving to manual driving is set using information regarding a destination that has been input via the navigation apparatus 21 mounted in the passenger car 20 and an IC closest to the destination. However, the invention is not limited thereto.

For example, regarding setting of a switching zone, input of a destination is not necessary, and when it is detected that traffic congestion has occurred on a road on which a vehicle is traveling, a switching zone for switching from automated driving to manual driving may be automatically set before the traffic congestion zone.

In addition, for example, on a road or the like on which traffic congestion frequently occurs, a switching zone may be set in advance in order to switch from automated driving to manual driving before a point at which traffic congestion occurs. In this case, checking before entering a control execution zone and re-checking before entering the switching zone may be performed using communication between a communication apparatus mounted in the passenger car and communication apparatuses or the like installed on the road side of the checkpoints and the re-check point.

### (F)

In the above embodiment, description has been given with an example in which an image captured by the camera 22 mounted in the passenger car 20 and a detection result by the sensor 23 are combined to monitor the state of the driver. However, the invention is not limited thereto.

For example, as an apparatus that monitors the state of the driver, or only a camera may be used, or only a sensor may be used.

### (G)

In the above embodiment, description has been given with an example in which the orientation of the face of a driver, the direction of a line of sight, the position of pupils, the speed of movement, a brain wave, a heart rate, and the like are obtained using an image shot by a camera and a detection result by a sensor as a parameter for determining whether or not the driver is in a state of being able to cope with manual driving. However, the invention is not limited thereto.

Another parameter may be used to determine the state of the driver, for example, a contact sensor is used to detect whether or not the driver is holding the steering wheel, or whether or not a foot is placed on the accelerator or the brake.

### (H)

In the above embodiment, description has been given with an example in which manual driving recovery levels of a driver during automated driving are classified into three steps, namely, Levels 1 to 3. However, the invention is not limited thereto.

For example, the number of steps of level setting is not limited to three, and two levels indicating whether or not manual driving can be coped with may be set.

Alternatively, four levels or more may be set, for example, a sleeping state from among states of a driver that are classified as Level 3 is set as Level 4.

### (I)

In the above embodiment, description has been given with an example in which, in the case where, while the passenger car 20 is traveling through automated driving, it is envisioned that a predetermined time or more is required for the driver to be able to cope with manual driving, the passenger car 20 is automatically stopped on a side strip of the road on which the passenger car 20 is traveling, as a shelter area. However, the invention is not limited thereto.

For example, a parking area, a service area or the like may be set as a shelter area in which a passenger car is automatically stopped in the case where a passenger car is traveling on a highway.

In the case where a passenger car is traveling on a public road, the passenger car may be automatically stopped in a parking lot such as a coin parking lot instead of a side strip.

### (J)

In the above embodiment, description has been given with an example in which the automated driving assistance apparatus 10 of the invention is mounted in the passenger car 20. However, the invention is not limited thereto.

For example, the automated driving assistance apparatus 10 may be mounted in other vehicles to which the application of automated driving is envisioned such as vehicles such as trains, buses, and truck, and ships and work vehicles, in addition to a passenger car.

### INDUSTRIAL APPLICABILITY

The automated driving assistance apparatus of the invention provides an effect of enabling provision of appropriate support according to the state of the driver when switching from automated driving to manual driving, and thus can be widely applied to various apparatuses that assist automated driving.

### INDEX TO THE REFERENCE NUMERALS

10 Automated driving assistance apparatus
11 Input reception unit
12 Switching zone/control execution zone setting unit
13 Driver monitoring unit
14 Manual driving recovery level setting unit
15 Memory
16 Manual driving recovery time calculation unit
17 Alert generation unit
18 Driving control unit (automatic stop control unit)
20 Passenger car (vehicle)
21 Navigation apparatus
22 Camera
23 Sensor
50 Automated driving assistance system
110 Automated driving assistance apparatus
118 Driving control unit (deceleration control unit, automatic stop control unit)
150 Automated driving assistance system
210 Automated driving assistance apparatus
250 Automated driving assistance system
310 Automated driving assistance apparatus
350 Automated driving assistance system
EX IC exit
HW Highway
IC Interchange
P1 Checkpoint
P2 Re-check point
Z1 Control execution zone
Z2 Switching zone

1. An automated driving assistance apparatus for assisting automated driving control of a vehicle, comprising:
a driver monitoring unit configured to monitor a state of a driver that is driving the vehicle; and
a manual driving recovery level setting unit configured to set, in a stepwise manner, a level indicating whether or not a switch can be made from automated driving to manual driving in a predetermined switching zone, based on the state of the driver detected by the driver monitoring unit.

2. The automated driving assistance apparatus according to claim 1, further comprising:
a manual driving recovery time calculation unit configured to estimate a time before the driver can cope with manual driving, according to the level that has been set in a stepwise manner by the manual driving recovery level setting unit.

3. The automated driving assistance apparatus according to claim 2, further comprising:
an alert generation unit configured to issue an alert to the driver in a case where a time calculated by the manual driving recovery time calculation unit exceeds a time required to travel to the switching zone.

4. The automated driving assistance apparatus according to claim 2, further comprising:
an automatic stop control unit configured to automatically stop the vehicle in a shelter area in a case where a time calculated by the manual driving recovery time calculation unit exceeds a time required to travel to the switching zone.

5. The automated driving assistance apparatus according to claim 1, further comprising:
a speed control unit configured to reduce a traveling speed of the vehicle for all or part of a distance to the switching zone during the automated driving, according to the level that has been set in a stepwise manner by the manual driving recovery level setting unit.

6. The automated driving assistance apparatus according to claim 5, further comprising:
an alert generation unit configured to issue an alert to the driver in a case where a traveling speed that is reduced by the speed control unit is lower than a minimum speed.

7. The automated driving assistance apparatus according to claim 5, further comprising:
an automatic stop control unit configured to automatically stop the vehicle in a shelter area in a case where a traveling speed that is reduced by the speed control unit is lower than a minimum speed.

8. The automated driving assistance apparatus according to claim 1,
wherein the state of the driver that is detected by the driver monitoring unit includes one of a speed/size of movement, a direction of a line of sight, and an orientation/position of a face.

9. The automated driving assistance apparatus according to claim 1,
wherein the driver monitoring unit detects the state of the driver using at least one of an image of the driver obtained by a camera installed in the vehicle and biological information of the driver that is obtained by a sensor.

10. An automated driving assistance apparatus for assisting automated driving control of a vehicle, comprising:
a driver monitoring unit configured to monitor a state of a driver that is driving the vehicle; and
a manual driving recovery time calculation unit configured to estimate a time before the driver can cope with manual driving, based on the state of the driver detected by the driver monitoring unit.

11. An automated driving assistance system comprising:
the automated driving assistance apparatus according to claim 1; and
a camera configured to capture an image of the driver that is transmitted to the driver monitoring unit.

12. An automated driving assistance system comprising:
the automated driving assistance apparatus according to claim 1; and
a sensor configured to obtain biological information of the driver that is transmitted to the driver monitoring unit.

13. An automated driving assistance method for assisting automated driving control of a vehicle, the method comprising:
monitoring a state of a driver that is driving the vehicle; and
setting, in a stepwise manner, a level indicating whether or not a switch can be made from automated driving to manual driving in a predetermined switching zone, based on the state of the driver detected in the monitoring.

14. A non-transitory computer-readable recording medium storing an automated driving assistance program for assisting automated driving control of a vehicle, the program causing a computer to execute an automated driving assistance method comprising:
monitoring a state of a driver that is driving the vehicle; and
setting, in a stepwise manner, a level indicating whether or not a switch can be made from automated driving to manual driving in a predetermined switching zone, based on the state of the driver detected in the monitoring.

15. An automated driving assistance method for assisting automated driving control of a vehicle, the method comprising:
monitoring a state of a driver that is driving the vehicle; and
estimating a time before the driver can cope with manual driving, based on the state of the driver detected in the monitoring.

16. A non-transitory computer-readable recording medium storing an automated driving assistance program for assisting automated driving control of a vehicle, the program causing a computer to execute an automated driving assistance method comprising:
monitoring a state of a driver that is driving the vehicle; and
estimating a time before the driver can cope with manual driving, based on the state of the driver detected in the monitoring.
